(19) United States
(12) Patent Application Publication
(10) Pub. No.: US 2025/0387883 A1
(43) Pub. Date: Dec. 25, 2025

(54) Locknut Driving Tool

(71) Applicant: Milwaukee Electric Tool Corporation, Brookfield, WI (US)

(72) Inventors: Michael Heggen Inouye, Pewaukee, WI (US); Nicholas Chung, Milwaukee, WI (US); Connor Fitzgerald, West Allis, WI (US); Cheng Zhang Li, Sussex, WI (US); Matthew A. Wills, Shorewood, WI (US); Ryan Ellsworth, Chanhassen, MN (US); Charlie G. Noble, New Berlin, WI (US); Matthew A. Lownik, Wauwatosa, WI (US); Monroe Dinh, Franklin, WI (US)

(21) Appl. No.: 19/202,795

(22) Filed: May 8, 2025

Related U.S. Application Data
(60) Provisional application No. 63/662,765, filed on Jun. 21, 2024.
(60) Provisional application No. 63/709,012, filed on Oct. 18, 2024.
(60) Provisional application No. 63/726,893, filed on Dec. 2, 2024.

(51) Int. Cl. B25B 13/48; B25B 13/56; B25G 1/10

(52) U.S. Cl. CPC B25B 13/48; B25B 13/56; B25G 1/10

(57) ABSTRACT

Various embodiments of a hand tool configured to engage and drive a locknut are provided. In various embodiments, the tool is a locknut wrench including a handle with an arm extending, such as at an angle, between the handle and the head. The head includes one or more tabs that engage fasteners, such as locknuts.

### CROSS-REFERENCE TO RELATED PATENT APPLICATIONS

The present application claims the benefit of and priority to U.S. Provisional Application No. 63/726,893 filed on Dec. 2, 2024, U.S. Provisional Application No. 63/709,012 filed on Oct. 18, 2024, and U.S. Provisional Application No. 63/662,765 filed on Jun. 21, 2024, each of which is incorporated herein by reference in its entirety.

### BACKGROUND OF THE INVENTION

The present disclosure is directed generally to the field of hand tools. The present disclosure relates specifically to tools configured to engage and drive locknuts.

### SUMMARY OF THE INVENTION

Various embodiments of the invention relate to a hand tool configured to engage and drive a locknut. In specific embodiments, the tool is configured to engage multiple different sized locknuts.

One embodiment of the invention relates to a locknut wrench including a handle configured to be gripped by a user, the handle extending along a first longitudinal axis, an arm extending from the handle along a second longitudinal axis that defines a first non-zero angle with respect to the first longitudinal axis, a bar extending from the arm along a plane that is parallel to the first longitudinal axis, the bar extending from the arm in a first direction to a first end and the bar extending from the arm in a second direction opposite the first direction to a second end, a first tab extending from the first end of the bar away from the handle, and a second tab extending from the second end of the bar away from the handle, the first tab and the second tab configured to collectively engage a locknut.

Another embodiment of the invention relates to a locknut wrench including a handle configured to be gripped by a user, the handle extending along a first longitudinal axis from a first end to a second end, the handle defining an aperture configured to receive a coupling device, wherein the aperture is closer to the second end than the first end, an arm extending from the first end of the handle along a second longitudinal axis that defines a first non-zero angle with respect to the first longitudinal axis, a bar extending from the arm along a plane that defines a second non-zero angle relative to the second longitudinal axis, the bar extending from a third end to a fourth end, a first tab extending from the third end of the bar away from the handle, and a second tab extending from the fourth end of the bar away from the handle, the first tab and the second tab configured to collectively engage a locknut.

Another embodiment of the invention relates to a set of locknut wrenches including a first locknut wrench, a second locknut wrench, and a third locknut wrench. The first locknut wrench includes a first handle configured to be gripped by a user, the first handle extending along a first longitudinal axis, a first arm extending from the first handle along a second longitudinal axis that defines a first non-zero angle with respect to the first longitudinal axis, a first bar extending from the first arm along a first plane that defines a second non-zero angle relative to the second longitudinal axis, a first tab located on the first bar, and a second tab located on the first bar, the first tab and the second tab configured to collectively engage a first locknut. The second locknut wrench includes a second handle configured to be gripped by a user, the second handle extending along a third longitudinal axis, the second handle including a magnet, a second arm extending from the second handle along a fourth longitudinal axis that defines a third non-zero angle with respect to the third longitudinal axis, a second bar extending from the second arm along a second plane that defines a fourth non-zero angle relative to the fourth longitudinal axis, a third tab located on the second bar, and a fourth tab located on the second bar, the third tab and the fourth tab configured to collectively engage a second locknut. The third locknut wrench includes a third handle configured to be gripped by a user, the third handle extending along a fifth longitudinal axis, a third arm extending from the third handle along a sixth longitudinal axis that defines a fifth non-zero angle with respect to the sixth longitudinal axis, a third bar extending from the third arm along a third plane that defines a sixth non-zero angle relative to the sixth longitudinal axis, a fifth tab located on the third bar, and a sixth tab located on the third bar, the fifth tab and the sixth tab configured to collectively engage a third locknut. The magnet is configured to contemporaneously engage the first locknut wrench on a first side of the second handle and engage the third locknut wrench on an opposing second side of the second handle.

Another embodiment of the invention relates to a locknut wrench including a handle configured to be gripped by a user, the handle extending along a first longitudinal axis, an arm extending from the handle along a second longitudinal axis, a curved head bar extending from the arm, the curved head bar defining a plane parallel to the first axis, the curved head bar extending from a first end to a second end, a first tab extending from the first end of the curved head bar away from the handle, and a second tab extending from the second end of the curved head bar away from the handle, the first tab and the second tab configured to collectively engage a locknut. The second longitudinal axis defines an angle with respect to the first longitudinal axis that is between 80 degrees and 100 degrees.

In a specific embodiment, the bar defines a lower surface that faces away from the handle, and each of the first tab and the second tab extend past the lower surface. In use, the lower surface interfaces against a locknut that the first tab and the second tab are engaging against. In a specific embodiment, the bar circumferentially extends a first angle between the first tab and the arm, and the bar circumferentially extends a second angle between the second tab and the arm, wherein the second angle is different than the first angle. In a specific embodiment, each of the first angle and the second angle are at least 60 degrees. In a specific embodiment, the first angle is between 85 degrees and 95 degrees, and the second angle is between 70 degrees and 80 degrees. In a specific embodiment, the second angle is less than the first angle.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a locknut wrench set, according to an exemplary embodiment.

FIG. 2 is a side view of the locknut wrench set of FIG. 1, according to an exemplary embodiment.

FIG. 3 is a top view of the locknut wrench set of FIG. 1, according to an exemplary embodiment.

FIG. 4 is a perspective view of a locknut wrench of the locknut wrench set of FIG. 1, according to an exemplary embodiment.

FIG. 5 is a side view of the locknut wrench of FIG. 4, according to an exemplary embodiment.

FIG. 6 is a detailed side view of the locknut wrench of FIG. 4, according to an exemplary embodiment.

FIG. 7 is a top view of the locknut wrench of FIG. 4, according to an exemplary embodiment.

FIG. 8 is a detailed top view of the locknut wrench of FIG. 4, according to an exemplary embodiment.

FIG. 9 is a detailed perspective view from below of the locknut wrench of FIG. 4, according to an exemplary embodiment.

FIG. 10 is a bottom view of the locknut wrench of FIG. 4, according to an exemplary embodiment.

FIG. 11 is a perspective view of a locknut wrench of the locknut wrench set of FIG. 1, according to an exemplary embodiment.

FIG. 12 is a bottom view of the locknut wrench of FIG. 11, according to an exemplary embodiment.

FIG. 13 is a perspective view of a locknut wrench of the locknut wrench set of FIG. 1, according to an exemplary embodiment.

FIG. 14 is a bottom view of the locknut wrench of FIG. 13, according to an exemplary embodiment.

FIG. 15 is a perspective view of a locknut wrench set, according to another exemplary embodiment.

FIG. 16 is a perspective view of a locknut wrench of the locknut wrench set of FIG. 15 and a locknut, according to an exemplary embodiment.

FIG. 17 is several side views of a locknut wrench, according to another exemplary embodiment.

FIG. 18 is a side view of a locknut wrench, according to another exemplary embodiment.

FIG. 19 is a side view of a locknut wrench, according to another exemplary embodiment.

FIG. 20 is a side view of a locknut wrench, according to another exemplary embodiment.

FIG. 21 is a side view of a locknut wrench, according to another exemplary embodiment.

FIG. 22 is a side view of a locknut wrench, according to another exemplary embodiment.

FIG. 23 is a schematic side view of a locknut wrench, according to another exemplary embodiment.

FIG. 24 is a side view of a nut driver, according to another exemplary embodiment.

FIG. 25 is a perspective view of the nut driver of FIG. 24, according to an exemplary embodiment.

FIG. 26 is a perspective view of the nut driver of FIG. 24, according to an exemplary embodiment.

FIG. 27 is a perspective view of the nut driver of FIG. 24, according to an exemplary embodiment.

FIG. 28 is a schematic view of the nut driver of FIG. 24, according to an exemplary embodiment.

FIG. 29 is a schematic view of a locknut wrench, according to another exemplary embodiment.

FIG. 30 is a schematic view of a locknut wrench, according to another exemplary embodiment.

FIG. 31 is a schematic view of a locknut wrench, according to another exemplary embodiment.

FIG. 32 is a schematic view of a locknut wrench, according to another exemplary embodiment.

FIG. 33 is a schematic view of a portion of a locknut wrench, according to another exemplary embodiment.

FIG. 34 is a schematic view of a portion of a locknut wrench, according to another exemplary embodiment.

FIG. 35 is a side view of a locknut wrench, according to another exemplary embodiment.

FIG. 36 is a schematic view of a locknut wrench, according to another exemplary embodiment.

FIG. 37 is a schematic view of a locknut wrench, according to another exemplary embodiment.

FIG. 38 is a schematic view of a locknut wrench, according to another exemplary embodiment.

FIG. 39 is a schematic view of a locknut wrench, according to another exemplary embodiment.

FIG. 40 is a schematic view of a locknut wrench, according to another exemplary embodiment.

FIG. 41 is a schematic view of a nut driver, according to another exemplary embodiment.

FIG. 42 is a schematic view of the nut driver of FIG. 41, according to an exemplary embodiment.

FIG. 43 is a side view of a plier, according to an exemplary embodiment.

FIG. 44 is a side view of the plier of FIG. 43, according to an exemplary embodiment.

FIG. 45 is a side view of a locknut wrench, according to an exemplary embodiment.

FIG. 46 is a schematic view of a locknut wrench, according to an exemplary embodiment.

### DETAILED DESCRIPTION

Referring generally to the figures, various embodiments of a hand tool configured to engage and drive a locknut are shown. In specific embodiments, the tool is configured to engage multiple different sized locknuts.

In specific embodiments shown, the tool is a locknut wrench including a handle with a twisted portion that extends to the head. In other embodiments, the locknut wrench includes a handle with a straight, untwisted portion that extends to the head. In specific embodiments, the head of the locknut wrench includes two downward projecting tabs at either end of the curved head bar. In such embodiments, these downward projecting tabs engage the locknut with the curved head bar resting on top of the locknut when engaged with the locknut. In specific embodiments, there are at least three different sized locknut wrenches shaped to stack or nest together. In such embodiments, the middle wrench (e.g., the ¾ inch wrench) includes a magnet (e.g., in the handle) to retain the smaller and larger wrench together when nested.

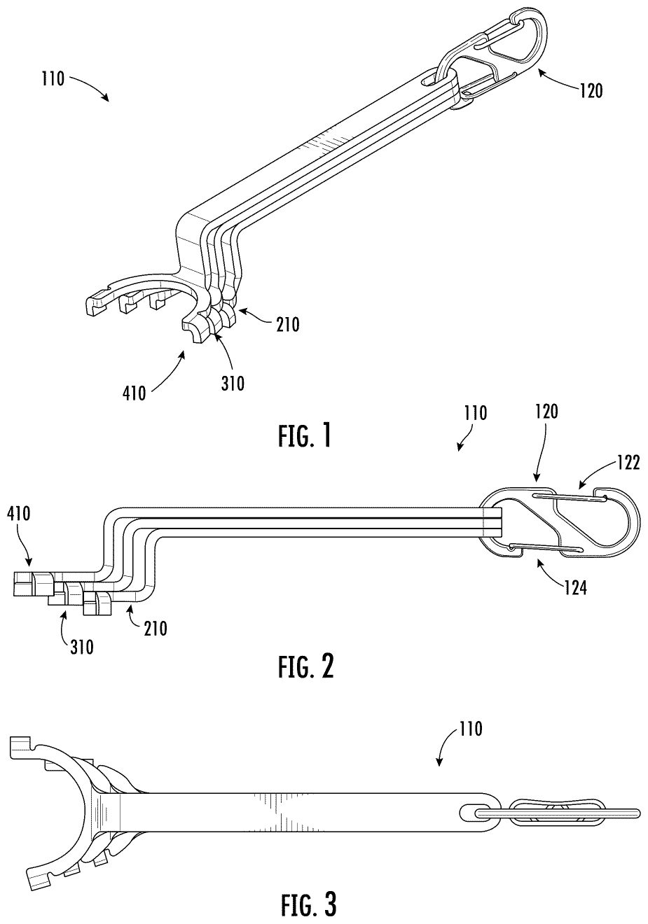

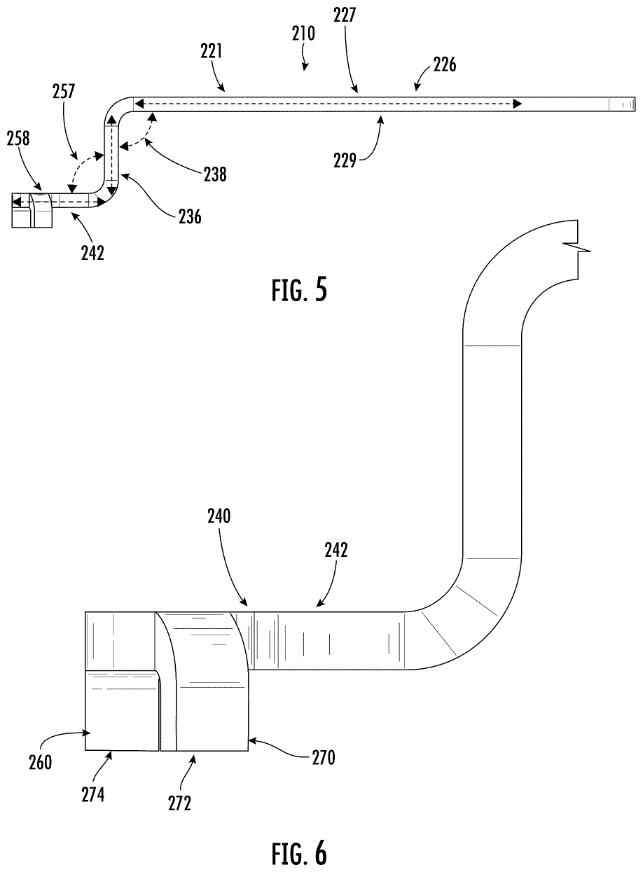

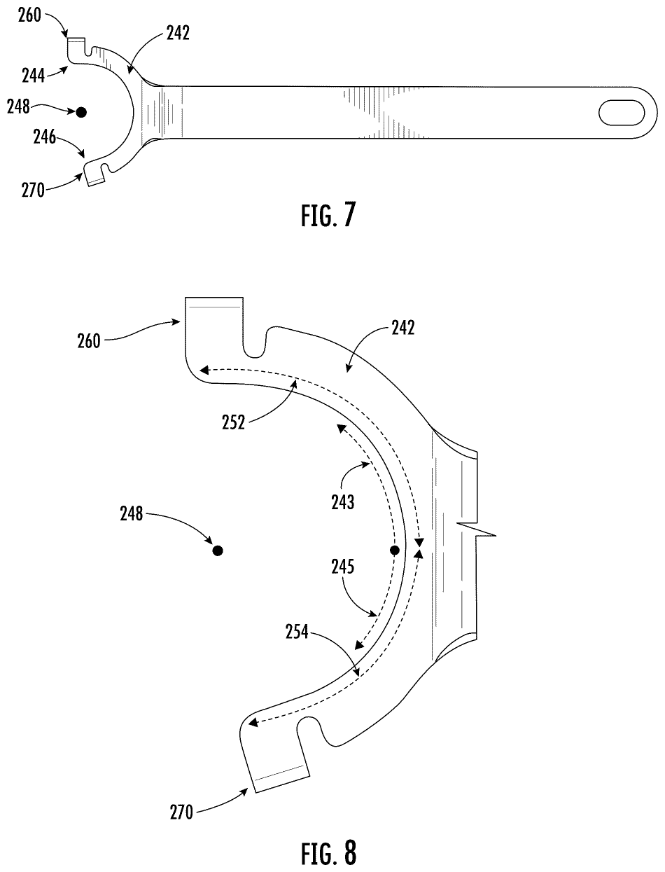

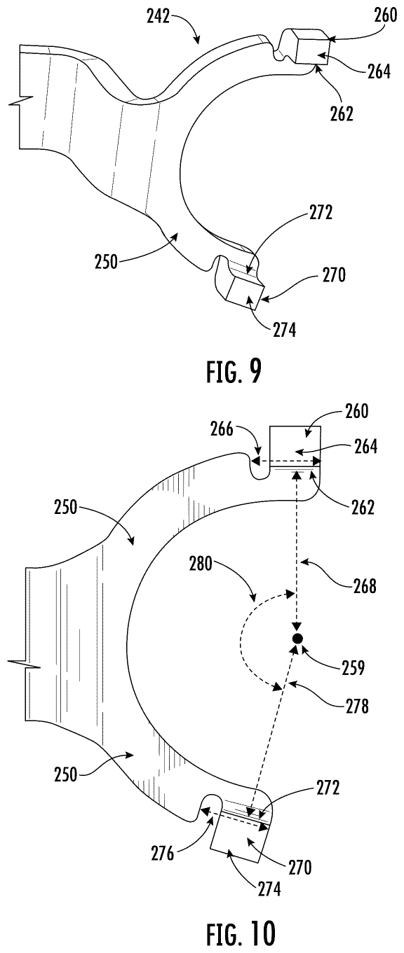

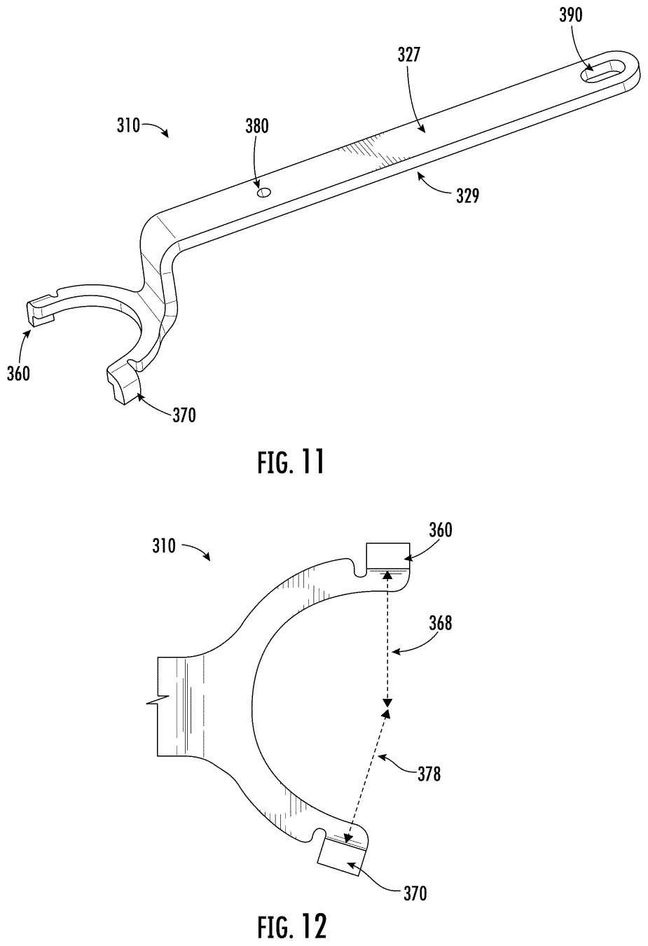

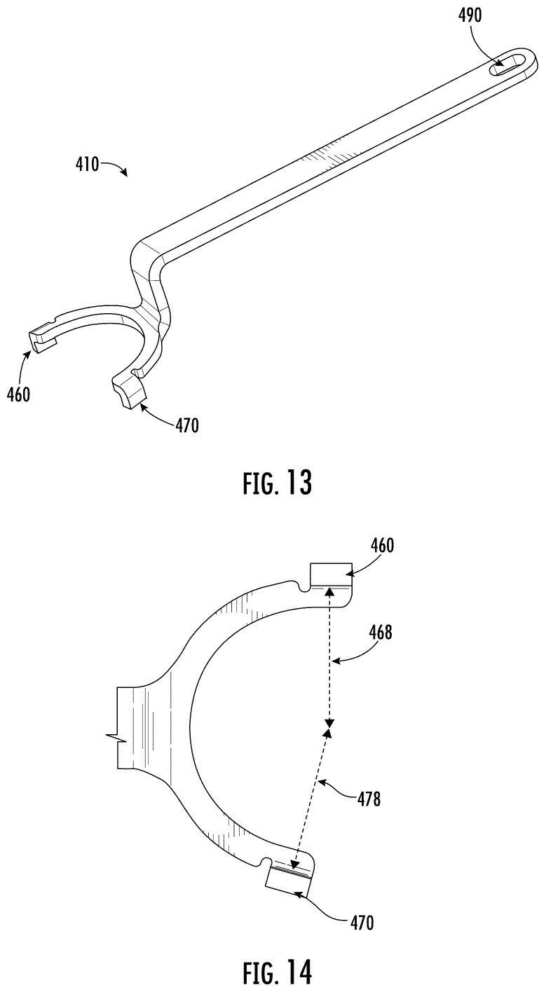

Referring to FIGS. 1-14, various aspects of locknut wrench set 110 are shown. A set of locknut wrenches 110 includes first locknut wrench 210, second locknut wrench 310, and third locknut wrench 410. Locknut wrench 210, locknut wrench 310, and locknut wrench 410 are coupled to clip 124 of attachment device 120, which can also be coupled to something else via clip 122, such as a loop, such as a belt loop.

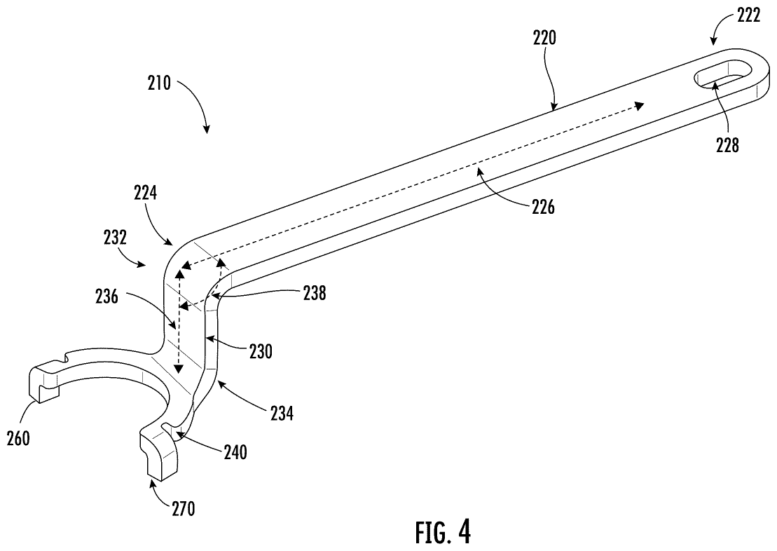

Referring to FIGS. 4-10, various aspects of locknut wrench 210 are shown. Locknut wrench 210 includes handle 220, arm 230 coupled to handle 220, and a head 240 including a wrench head, shown as curved head bar 242 coupled to arm 230.

Handle 220 is configured to be gripped by a user and handle 220 extends from first end 222 to second end 224 along a first longitudinal axis 226. Handle 220 is coupled to attachment device 120 via aperture 228. In various embodiments, handle 220 defines an aperture 228 configured to receive a coupling device, such as attachment device 220, and the aperture 228 is closer to the second end 224 than the first end 222. Arm 230 extends handle 220 from first end 232 to second end 234 along second longitudinal axis 236 that defines angle 238 with respect to longitudinal axis 226, and in various embodiments angle 238 is a non-zero angle. In various embodiments, second longitudinal axis 236 is perpendicular to first longitudinal axis 226. In various embodiments, arm 230, and bar 240 are both positioned on second side 229 of handle 220, which is opposite first side 227 of handle.

Second longitudinal axis 236 defines angle 238 with respect to first longitudinal axis 226 and/or upper surface 221 of handle 220. In various embodiments, upper surface 221 defines a plane that is parallel to first longitudinal axis 226 of handle 220. In various embodiments, angle 238 is between 80 degrees and 100 degrees, and more specifically between 85 degrees and 95 degrees, and even more specifically 90 degrees.

Curved head bar 242 extends from arm 230 along plane 258, which defines angle 257 with respect to second longitudinal axis 236. In various embodiments, angle 257 is non-zero. In various embodiments, plane 258 is parallel to first longitudinal axis 226. In various embodiments, plane 258 is perpendicular to second longitudinal axis 236. In various embodiments, plane 258 is parallel to a plane defined by lower surface 250. In various embodiments, angle 257 is between 80 and 100 degrees, and more specifically between 85 and 95 degrees, and even more specifically is 90 degrees.

Curved head bar 242 extends circumferentially from first end 244 to second end 246. Bar 242 extends from arm 230 in a first direction 243 to a first end 244 and bar 242 extends from arm 230 in a second direction 245 opposite the first direction 243 to a second end 246. In various embodiments, curved head bar 242 extends circumferentially around and is centered on axis 248. Curved head bar 242 defines lower surface 250 that faces away from handle 220. In various embodiments, each of first tab 260 and second tab 270 extend past lower surface 250. In use, lower surface 250 interfaces against a locknut that first tab 260 and second tab 270 are engaging against.

Curved head bar 242 circumferentially extends around axis 248 between first tab 260 and arm 230 a first angle 252, which is between 80 and 100 degrees, and more specifically between 85 and 95 degrees, and even more specifically is 90 degrees. Curved head bar 242 circumferentially extends around axis 248 between second tab 270 and arm 230 a second angle 254, which is between 65 and 85 degrees, and more specifically between 70 and 80 degrees, and even more specifically is 75 degrees. In various embodiments, second angle 254 is less than first angle 252. In various embodiments, second angle 254 and first angle 252 are each at least 60 degrees. In various embodiments, second angle 254 is at least 10 degrees less than first angle 252. In various embodiments, second angle 254 is no more than 20 degrees less than first angle 252. In various embodiments, second angle 254 is between 10 degrees and 20 degrees, inclusively, less than first angle 252.

First tab 260 and second tab 270 extend from curved head bar 242. In various embodiments, first tab 260 extends from first end 244 of the bar 242 away from the handle 220, and second tab 270 extends from the second end 246 of the bar 242 away from the handle 220, and the first tab 260 and the second tab 270 are configured to collectively engage a locknut. First tab 260 defines inner surface 262 facing generally towards second tab 270, and second tab 270 defines inner surface 272 facing generally towards first tab 260. Inner surface 262 defines plane 266, and inner surface 272 defines plane 276. First tab 260 defines lower surface 264, and second tab 270 defines lower surface 274, each of which face away from handle 220.

First tab 260 is radius 268 from tab center 259, and second tab 270 is radius 278 from tab center 259. In various embodiments, radius 268 and radius 278 define angle 280, which is between 165 degrees and 185 degrees, and more specifically between 170 and 180 degrees, and even more specifically is 175 degrees.

In use, first tab 260 and second tab 270 engage against features of a locknut to facilitate a user rotating handle 220 to cause rotation of the locknut. For example, first tab 260 engages against protrusions or recesses of a locknut (e.g., see locknut 540 in FIG. 16), and second tab 270 engages against protrusions or recesses of a locknut (e.g., see locknut 540 in FIG. 16).

Referring to FIGS. 11-14, various aspects of locknut wrench 310 and locknut wrench 410 are shown. Locknut wrench 310 and locknut wrench 410 are substantially the same as locknut wrench 210 except for the differences discussed herein. In particular, locknut wrench 310 is bigger than locknut wrench 210, and locknut wrench 410 is bigger than both locknut wrench 310 and locknut wrench 210.

Locknut wrench 310 includes first tab 360 defining radius 368 and second tab 370 defining radius 378. Radius 368 and radius 378 are bigger than radius 268 and radius 278.

Locknut wrench 410 includes first tab 460 defining radius 468 and second tab 470 defining radius 478. Radius 468 and radius 478 are bigger than radius 268 and radius 278 and radius 368 and radius 378.

In various embodiments, set of locknut wrenches 110 includes first locknut wrench 210, second locknut wrench 310, and third locknut wrench 410. In various embodiments, first locknut wrench 210 includes a first handle 220 configured to be gripped by a user, the first handle 210 extending along a first longitudinal axis 226, a first arm 230 extending from the first handle 220 along a second longitudinal axis 236 that defines a first non-zero angle 238 with respect to the first longitudinal axis 226, first bar 242 extending from the first arm 230 along a first plane 258 that defines a second non-zero angle 257 relative to the second longitudinal axis 236, a first tab 260 located on the first bar 242, and a second tab 270 located on the first bar 242, the first tab 260 and the second tab 270 configured to collectively engage a first locknut.

In various embodiments, second locknut wrench 310 and third locknut wrench 410 are structurally and functionally the same as first locknut wrench 210 except as otherwise noted. In particular, second locknut wrench 310 is larger than first locknut wrench 210 and tabs of second locknut wrench 310 are further apart than tabs of first locknut wrench 210 and are thus configured to engage with a second locknut, and third locknut wrench 410 is larger than each of first locknut wrench 210 and second locknut wrench 310 and are thus configured to engage with a third locknut.

In various embodiments, second locknut wrench 310 includes a second handle configured to be gripped by a user, the second handle extending along a third longitudinal axis, the second handle including a magnet 380, a second arm extending from the second handle along a fourth longitudinal axis that defines a third non-zero angle with respect to the third longitudinal axis, a second bar extending from the second arm along a second plane that defines a fourth non-zero angle relative to the fourth longitudinal axis, a third tab located on the second bar, and a fourth tab located on the second bar, the third tab and the fourth tab configured to collectively engage the locknut. In various embodiments, second locknut wrench 310 includes aperture 390 configured to engage with attachment device 120.

In various embodiments, third locknut wrench 410 includes a third handle configured to be gripped by a user, the third handle extending along a fifth longitudinal axis, a third arm extending from the third handle along a sixth longitudinal axis that defines a fifth non-zero angle with respect to the sixth longitudinal axis, a third bar extending from the third arm along a third plane that defines a sixth non-zero angle relative to the sixth longitudinal axis, a fifth tab located on the third bar, and a sixth tab located on the third bar, the fifth tab and the sixth tab configured to collectively engage the locknut. In various embodiments, third locknut wrench 410 includes aperture 490 configured to engage with attachment device 120.

In various embodiments, magnet 380 is configured to contemporaneously engage the first locknut wrench 210 on a first side 327 of the second handle and engage the third locknut wrench 410 on an opposing second side 329 of the second handle. In this way, locknut wrenches 210, 310, and 410 are configured to be magnetically coupled to each other, thereby facilitating a user carrying and/or storing locknut wrenches 210, 310, and 410.

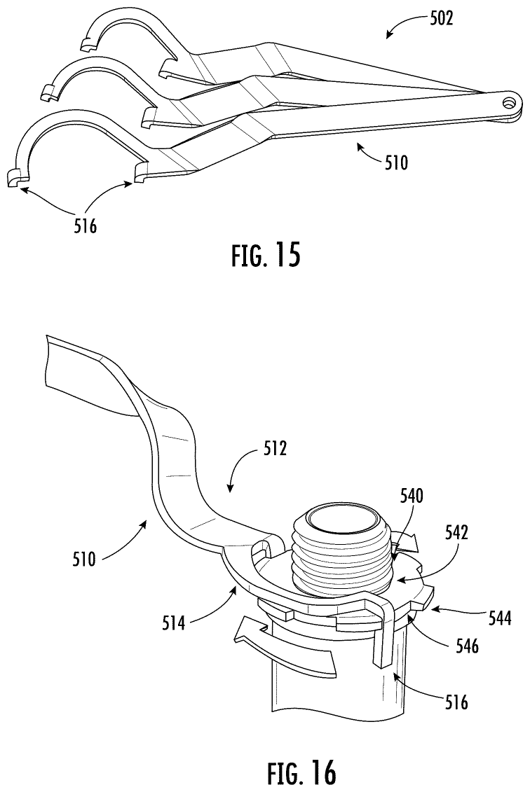

Referring to FIGS. 15-16, various aspects of locknut system 502 are shown. Locknut system 502 includes locknut wrench 510, which includes arm 512, head 514 extending from arm 512, and tabs 516 extending from head 514. Tabs 516 engage with locknuts, such as locknut 540. Locknut 540 includes body 542, projections 544 radially out from body 542, and recesses 546 extending circumferentially between projections 544. The arm 512 extending downward from the handle at an acute angle between 0 and 90 degrees, exclusively, facilitates locknut wrench 510 stably engaging with locknut 540 for turning in either rotational direction.

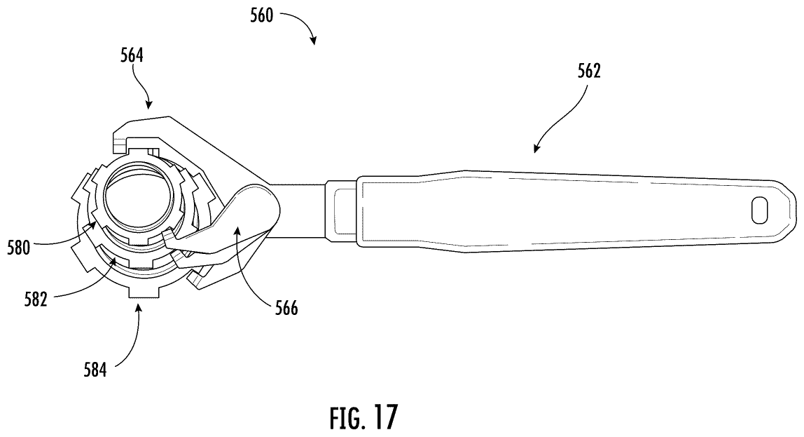

Referring to FIG. 17, various aspects of locknut wrench 560 are shown. Locknut wrench 560 includes handle 562, first arm 564 coupled to and extending from handle 562, such as rigidly coupled, and second arm 566 coupled to and extending from handle 562, such as pivotally coupled. FIG. 17 depicts second arm 566 in three different positions, each of can be used to engage one of locknut 580, locknut 582, and locknut 584.

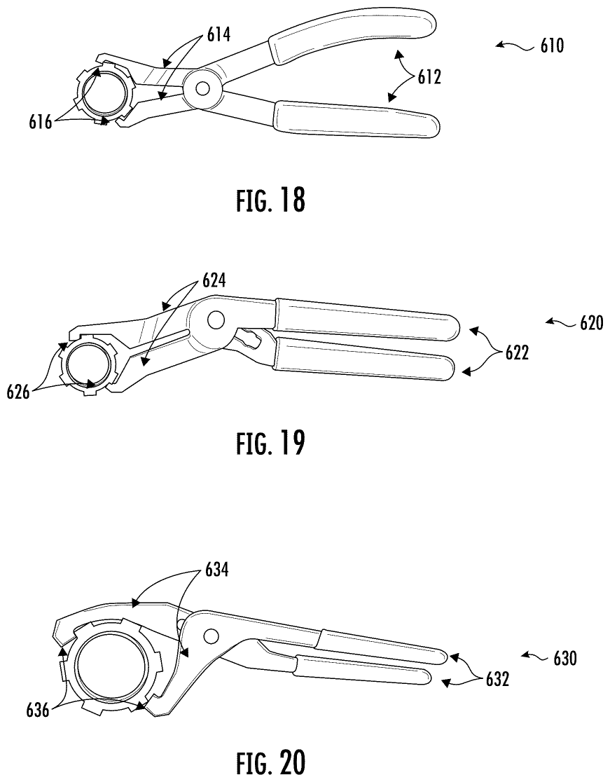

Referring to FIGS. 18-20, various aspects of pliers 610, pliers 620, and pliers 630 are shown. Pliers 610 include handles 612, arms 614 coupled to and extending from handles 612, and tabs 616 extending from arms 614. Handles 612 and arms 614 are pivotally coupled to facilitate engaging locknuts with tabs 616. Pliers 620 include handles 622, arms 624 coupled to and extending from handles 622, and tabs 626 extending from arms 624. Handles 622 and arms 624 are pivotally coupled to facilitate engaging locknuts with tabs 626. Pliers 630 include handles 632, arms 634 coupled to and extending from handles 632, and tabs 636 extending from arms 634. Handles 632 and arms 634 are pivotally coupled to facilitate engaging locknuts with tabs 636.

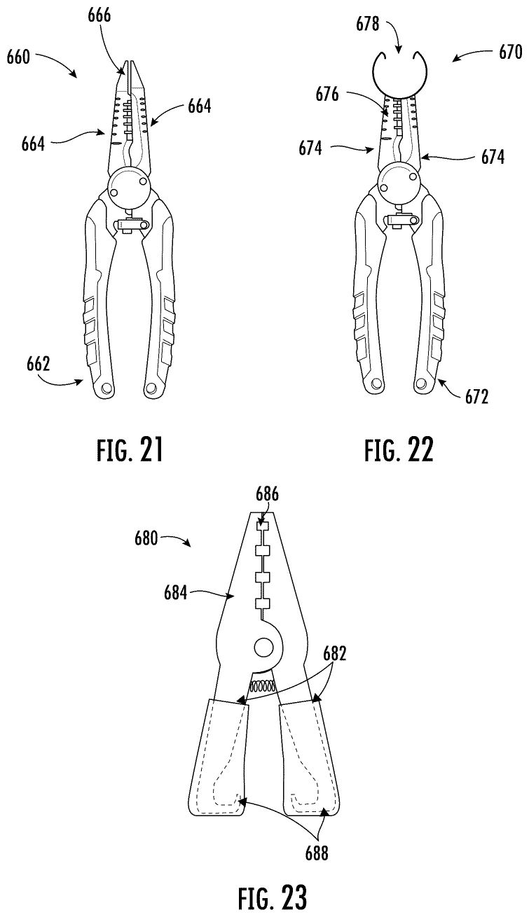

Referring to FIGS. 21-22, various aspects of pliers 660, pliers 670, and pliers 680 are shown. Pliers 660 include handles 662, arms 664 coupled to and extending from handles 662, and engagement surfaces 666 defined by arms 664. In various embodiments, part and/or all of engagement surfaces 666 can be used for wire stripping. Pliers 670 include handles 672, arms 674 coupled to and extending from handles 672, and engagement surfaces 676 defined by arms 674. In various embodiments, part and/or all of engagement surfaces 676 can be used for wire stripping. Pliers 670 includes hook(s) 678 coupled to end of arms 674 to engage objects, such as locknuts. Pliers 680 include handles 682, arms 684 coupled to and extending from handles 682, and engagement surfaces 686 defined by arms 684 that engage with locknuts and/or wires. Handles 682 include covered hooks 688 that can be used to engage objects, such as locknuts.

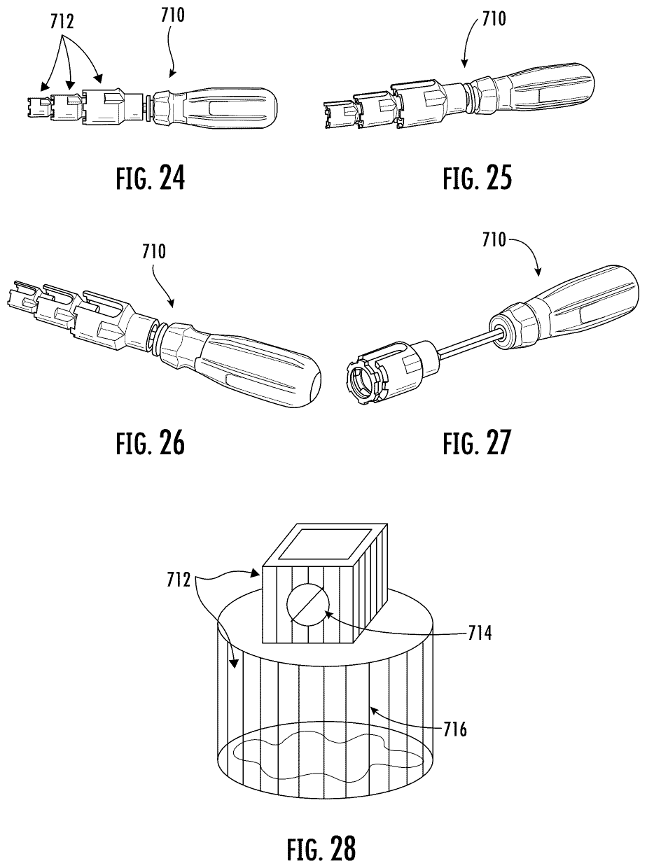

Referring to FIGS. 24-28, various aspects of nut driver 710 are shown. Nut driver 710 includes sockets 712 that detachably engage with the handle to facilitate turning fasteners. In various embodiments, one or more of sockets 712 includes a fastener, shown as screw 714, to couple the respective socket 712 to an object, such as the handle. In various embodiments, one or more of sockets 712 includes knurling to facilitate rotating the respective socket 712, such as by hand. Cutouts in the sockets 712 enable users to work on locknuts even when wires are already in place, such as by extending the wire through the cutouts.

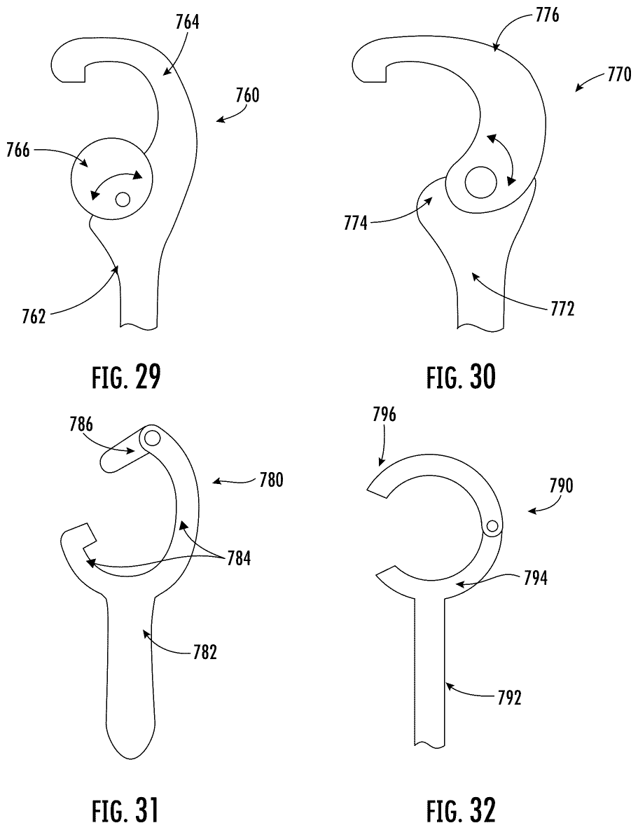

Referring to FIGS. 29-32, various aspects of locknut wrenches 760, 770, 780, and 790 are shown. Locknut wrench 760 includes handle 762, rigid arm 764 rigidly coupled to handle 762, and adjustable arm 766 pivotally coupled to handle 762. Rigid arm 764 and adjustable arm 766 collectively engage locknuts, and can be adjusted to engage locknut of varying sizes by moving adjustable arm 766.

Locknut wrench 770 includes handle 772, engagement surfaces 774 rigidly coupled to handle 772, and adjustable arm 776 pivotally coupled to handle 772. Engagement surfaces 774 and adjustable arm 776 collectively engage locknuts, and can be adjusted to engage locknut of varying sizes by moving adjustable arm 776.

Locknut wrench 780 includes handle 782, rigid arms 784 rigidly coupled to handle 782, and adjustable arm 786 pivotally coupled to one of rigid arms 784. Rigid arms 784 and adjustable arm 786 collectively engage locknuts, and can be adjusted to engage locknut of varying sizes by moving adjustable arm 786. In various embodiments, adjustable arm 786 is spring biased and/or includes a screw to adjust and/or lock the position of adjustable arm 786.

Locknut wrench 790 includes handle 792, rigid arms 794 rigidly coupled to handle 792, and adjustable arm 796 pivotally coupled to one of rigid arms 794. Rigid arm 794 and adjustable arm 796 collectively engage locknuts, and can be adjusted to engage locknut of varying sizes by moving adjustable arm 796.

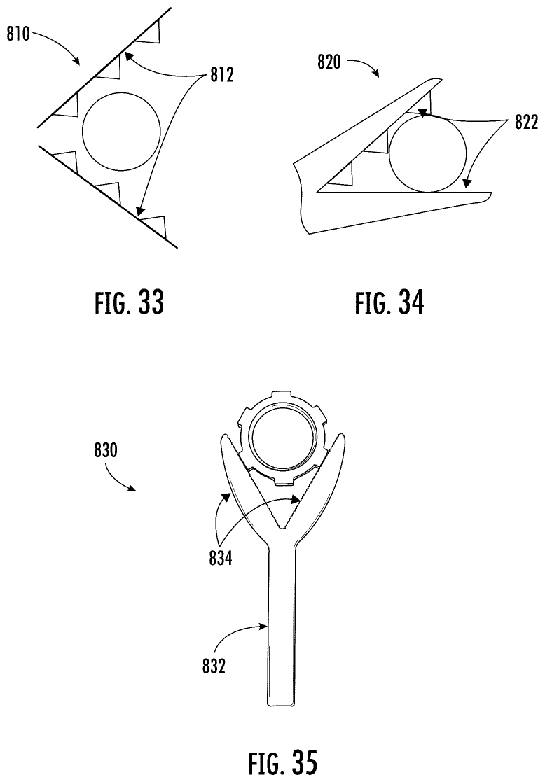

Referring to FIGS. 33-35, various aspects of locknut wrenches 810, 820, and 830 are shown. Locknut wrench 810 includes engagement surfaces 812 that pivot with respect to each other to engage a locknut. Locknut wrench 820 includes engagement surfaces 822 that pivot with respect to each other to engage a locknut. Locknut wrench 830 includes engagement surfaces 834 extending from handle 832 that pivot with respect to each other to engage a locknut.

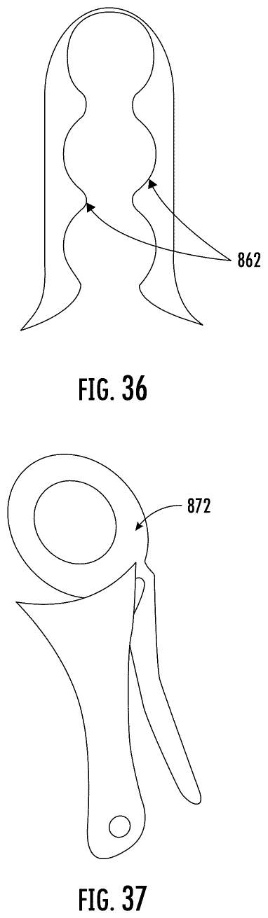

Referring to FIGS. 36-37, various aspects of locknut wrenches are shown. The locknut wrench of FIG. 36 includes engagement surfaces 862 that engage a locknut. The locknut wrench of FIG. 37 includes engagement surfaces 872 that engage a locknut.

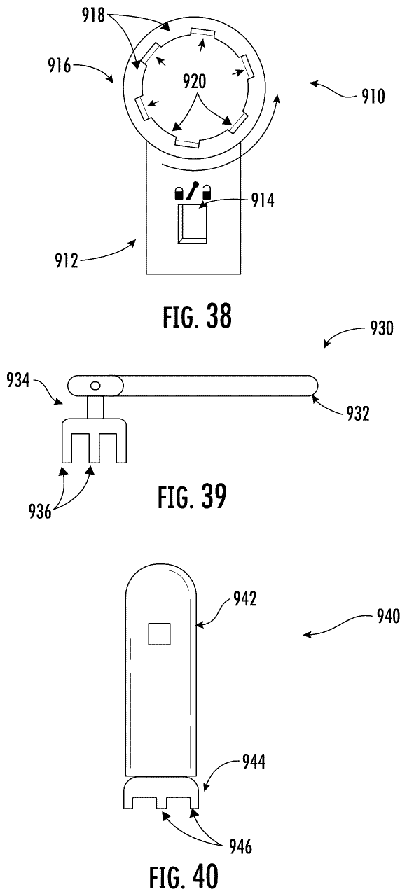

Referring to FIGS. 38-40, various aspects of locknut wrenches 910, 930, and 940 are shown. Locknut wrench 910 includes handle 912, an interface shown as button 914 coupled to handle 912, and head 916 coupled to handle 912. Head 916 includes projections 918 extending radially inward within head 916, and movable shelves 920 circumferentially extending between projections 918, the movable shelves 920 can be actuated towards and away from the center of head 916 to facilitate engaging and releasing locknuts. As one example, the user can press button 914 to move movable shelves 920 in a first direction (e.g., towards center of head 916), and then the user releasing button 914 permits movable shelves 920 to move opposite first direction, such as if the movable shelves 920 are spring biased opposite the first direction.

Referring to FIG. 39, locknut wrench 930 includes handle 932, head 934 coupled to handle 932, and teeth 936 extending from head 934. Teeth 936 are configured to engage locknuts.

Referring to FIG. 40, locknut wrench 940 includes handle 942, head 944 coupled to handle 942, and teeth 946 extending from head 944. Teeth 946 are configured to engage locknuts.

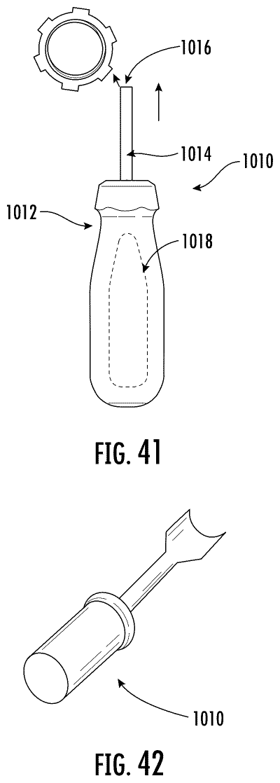

Referring to FIGS. 41-42, various aspects of nut driver 1010 are shown. Nut driver 1010 includes handle 1012, arm 1014 coupled to and extending from handle 1012, such as rigidly coupled, and head 1016 coupled to arm 1014, such as via being integrally molded, opposite handle 1012. In various embodiments arm 1014 is slidably coupled to handle 1012, and can be actuated outward to punch the arm 1014 forward, such as via cylinder 1018 releasing gas, such as carbon dioxide.

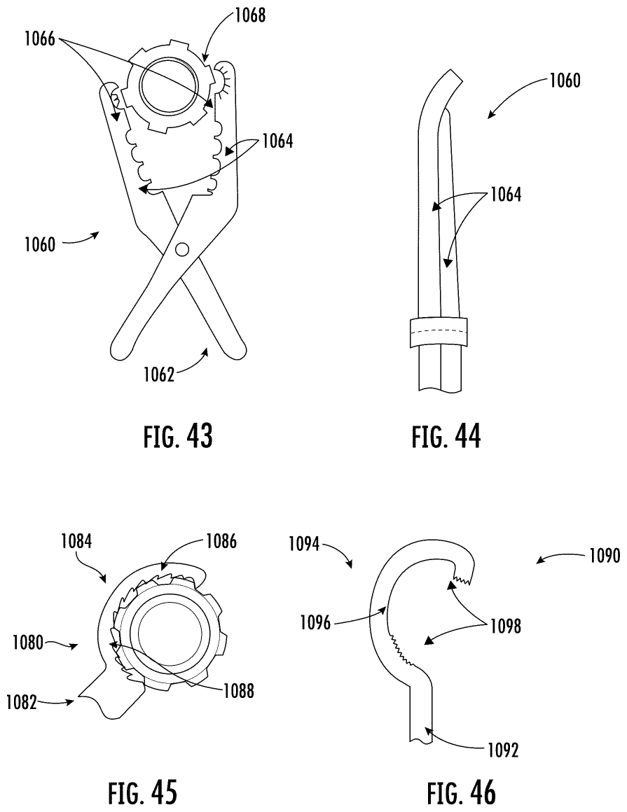

Referring to FIGS. 43-45, various aspects of pliers 1060 and locknut wrenches 1080 and 1090 are shown.

Pliers 1060 includes handles 1062, arms 1064 extending from handles 1062, engagement surfaces 1066 defined by at least part of arms 1064, the engagement surfaces configured to engage locknut 1068.

Locknut wrench 1080 includes handle 1082, head 1084 coupled to and extending from handle 1082, such as rigidly coupled, and engagement surface 1086. In various embodiments, engagement surface 1086 includes projections 1088 extending inward along the entirety of engagement surface 1086.

Locknut wrench 1090 includes handle 1092, head 1094 coupled to and extending from handle 1092, such as rigidly coupled, and engagement surface 1096. In various embodiments, engagement surface 1096 includes projections 1098 extending inward at opposing ends of engagement surface 1086.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A locknut wrench comprising:
a handle configured to be gripped by a user, the handle extending along a first longitudinal axis;
an arm extending from the handle along a second longitudinal axis that defines a first non-zero angle with respect to the first longitudinal axis;
a bar extending from the arm along a plane that is parallel to the first longitudinal axis, the bar extending from the arm in a first direction to a first end and the bar extending from the arm in a second direction opposite the first direction to a second end;
a first tab extending from the first end of the bar away from the handle; and
a second tab extending from the second end of the bar away from the handle, the first tab and the second tab configured to collectively engage a locknut.

2. The locknut wrench of claim 1, the bar defines a lower surface that faces away from the handle, wherein each of the first tab and the second tab extend past the lower surface.

3. The locknut wrench of claim 1, wherein the bar circumferentially extends between the first tab and the arm a first angle, and wherein the bar circumferentially extends between the second tab and the arm a second angle different than the first angle.

4. The locknut wrench of claim 3, wherein each of the first angle and the second angle are at least 60 degrees.

5. The locknut wrench of claim 3, wherein the first angle is between 85 degrees and 95 degrees, and wherein the second angle is between 65 degrees and 85 degrees.

6. The locknut wrench of claim 3, wherein the second angle is at least 10 degrees less than the first angle.

7. The locknut wrench of claim 3, wherein the second angle is between 10 and 20 degrees, inclusively, less than the first angle.

8. The locknut wrench of claim 1, wherein the second longitudinal axis is perpendicular to the first longitudinal axis.

9. The locknut wrench of claim 8, wherein the plane is perpendicular to the second longitudinal axis.

10. The locknut wrench of claim 1, wherein the plane is perpendicular to the second longitudinal axis.

11. A locknut wrench comprising:
a handle configured to be gripped by a user, the handle extending along a first longitudinal axis from a first end to a second end, the handle defining an aperture configured to receive a coupling device, wherein the aperture is closer to the second end than the first end;
an arm extending from the first end of the handle along a second longitudinal axis that defines a first non-zero angle with respect to the first longitudinal axis;
a bar extending from the arm along a plane that defines a second non-zero angle relative to the second longitudinal axis, the bar extending from a third end to a fourth end;
a first tab extending from the third end of the bar away from the handle; and
a second tab extending from the fourth end of the bar away from the handle, the first tab and the second tab configured to collectively engage a locknut.

12. The locknut wrench of claim 11, wherein the bar circumferentially extends between the first tab and the arm a first angle, and wherein the bar circumferentially extends between the second tab and the arm a second angle different than the first angle.

13. The locknut wrench of claim 12, wherein the second angle is at least 10 degrees less than the first angle.

14. The locknut wrench of claim 12, wherein the second angle is no more than 20 degrees less than the first angle.

15. The locknut wrench of claim 11, wherein the second longitudinal axis is perpendicular to the first longitudinal axis.

16. The locknut wrench of claim 13, wherein the plane is perpendicular to the second longitudinal axis.

17. A set of locknut wrenches comprising:
a first locknut wrench comprising:
a first handle configured to be gripped by a user, the first handle extending along a first longitudinal axis;
a first arm extending from the first handle along a second longitudinal axis that defines a first non-zero angle with respect to the first longitudinal axis;
a first bar extending from the first arm along a first plane that defines a second non-zero angle relative to the second longitudinal axis;
a first tab located on the first bar; and
a second tab located on the first bar, the first tab and the second tab configured to collectively engage a first locknut;
a second locknut wrench comprising:
a second handle configured to be gripped by a user, the second handle extending along a third longitudinal axis, the second handle comprising a magnet;
a second arm extending from the second handle along a fourth longitudinal axis that defines a third non-zero angle with respect to the third longitudinal axis;
a second bar extending from the second arm along a second plane that defines a fourth non-zero angle relative to the fourth longitudinal axis;
a third tab located on the second bar; and
a fourth tab located on the second bar, the third tab and the fourth tab configured to collectively engage a second locknut; and
a third locknut wrench comprising:
a third handle configured to be gripped by a user, the third handle extending along a fifth longitudinal axis;
a third arm extending from the third handle along a sixth longitudinal axis that defines a fifth non-zero angle with respect to the sixth longitudinal axis;
a third bar extending from the third arm along a third plane that defines a sixth non-zero angle relative to the sixth longitudinal axis;
a fifth tab located on the third bar; and
a sixth tab located on the third bar, the fifth tab and the sixth tab configured to collectively engage a third locknut;
wherein the magnet is configured to contemporaneously engage the first locknut wrench on a first side of the second handle and engage the third locknut wrench on an opposing second side of the second handle.

18. The set of locknut wrenches of claim 17, the first handle defining a first aperture configured to receive a coupling device, the second handle defining a second aperture configured to receive the coupling device, and the third handle defining a third aperture configured to receive the coupling device.

19. The set of locknut wrenches of claim 17, the first bar defines a lower surface that faces away from the first handle, wherein each of the first tab and the second tab extend past the lower surface, and wherein the first bar circumferentially extends between the first tab and the first arm a first angle, and wherein the first bar circumferentially extends between the second tab and the first arm a second angle different than the first angle.

20. The set of locknut wrenches of claim 17, wherein the second longitudinal axis is perpendicular to the first longitudinal axis, and wherein the first plane is perpendicular to the second longitudinal axis.
